(19) United States
(12) Patent Application Publication
(10) Pub. No.: US 2014/0147011 A1
(43) Pub. Date: May 29, 2014

(54) OBJECT REMOVAL DETECTION USING 3-D DEPTH INFORMATION

(71) Applicant: PELCO, INC., Clovis, CA (US)

(72) Inventor: Shu Yang, Clovis, CA (US)

(73) Assignee: PELCO, INC., Clovis, CA (US)

(21) Appl. No.: 13/689,158

(22) Filed: Nov. 29, 2012

(51) Int. Cl. G06T 7/20

(52) U.S. Cl. CPC G06T 7/2086
USPC 382/107

(57) ABSTRACT

A novel object removal detection method and corresponding apparatus is described. The method employs a combination of detecting a change in a scene pattern and a change in the depth of field. The method significantly reduced false alarms caused by occlusion or rearrangement of the monitored objects.

### BACKGROUND OF THE INVENTION

Object blockage and occlusion is a big challenge in object removal detection, causing significant false alarms. In a typical detection process, an image pattern of a protected object is obtained and later compared with the same area pattern in each frame. Any pattern change larger than a threshold produces an object removal alarm. Such a process cannot distinguish a pattern change caused by an object removal or object blockage.

### SUMMARY OF THE INVENTION

An example embodiment of the present invention is a method and a system for detecting an object removal from a monitored volume.

In one embodiment, the present invention is a method for monitoring a volume. The method comprises constructing a representation of a content in a reference image of a monitored volume to create a reference representation; assigning a reference depth of field value to the reference representation; constructing a representation of a content in a subsequent image of the monitored volume to create a subsequent representation, the subsequent image being time-ordered with respect to the reference image; and comparing the subsequent representation to the reference representation to determine motion of the content. In an event motion of the content is detected, the method further includes assigning a subsequent depth of field value to the subsequent representation; and comparing the subsequent and reference depth of field values of the subsequent representation, respectively, and the reference representation to determine whether the content was subjected to rearrangement, removal, or occlusion.

As used herein, the term “rearrangement” means that the volume being monitored, after a detection of movement, retained the content (e.g., an object) at approximately the same depth of field (e.g., the change in the depth of field is within user-specified or automatically determined tolerances). As used herein, the term “removal” means that the volume being monitored no longer includes the content at approximately the same depth of field. As used herein, the term “occlusion” means that the volume being monitored acquired a content at a depth of field that is less than that of the original content, while the original content can no longer be detected.

In another embodiment of the present invention, in an event the motion in the content is not detected, the method further includes replacing the subsequent image with a new subsequent image, time-ordered with respect to the subsequent image; constructing a representation of a content in the new subsequent image of the monitored volume to create a new subsequent representation; and comparing the new subsequent representation to the reference representation to determine motion of the content. In an event motion of the content was detected, the method further includes assigning a depth of field value to the subsequent representation and comparing the depth of field values of the subsequent representation and the reference representation to determine whether the content was subjected to rearrangement, removal or occlusion.

In another embodiment of the present invention, in an event the content was subjected to rearrangement, the method further includes replacing the reference image with a new reference image; constructing a representation of a content in the new reference image of the monitored volume to create a new reference representation; assigning a depth of field value to the new reference representation; constructing a representation of a content in a new subsequent image of the monitored volume to create a subsequent representation, the new subsequent image being time-ordered with respect to the new reference image; and comparing the new subsequent representation to the new reference representation to determine motion of the content. In an event motion of the content is detected, the method further includes assigning a depth of field value to the new subsequent representation and comparing the depth of field values of the new subsequent representation and the new reference representation to determine whether the content was subjected to rearrangement, removal, or occlusion.

In another embodiment of the present invention, in an event the content was subjected to removal, the method further includes producing a signal indicating removal.

In another embodiment of the present invention, in an event the content was subjected to occlusion, the method further includes timing the period of occlusion.

In one embodiment, the present invention is a system for monitoring an area. The system comprises an image processing module, configured to: construct a representation of a content in a reference image of a monitored volume to create a reference representation; assign a reference depth of field value to the reference representation; construct a representation of a content in a subsequent image of the monitored volume to create a subsequent representation, the subsequent image being time-ordered with respect to the reference image; compare the subsequent representation to the reference representation to determine motion of the content, and, in an event motion of the content is detected, to assign a subsequent depth of field value to the subsequent representation; and compare the subsequent and reference depth of field values of the subsequent representation and the reference representation, respectively, to determine whether the content was subjected to rearrangement, removal or occlusion.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A, 1B, 1C, and 1D are schematic diagrams illustrating the operation of the methods and system of the present invention.

FIG. 2A is a flow diagram illustrating a method according to an embodiment of the present invention.

FIG. 2B is a flow diagram illustrating a method according to an embodiment of the present invention.

FIG. 3 is a schematic diagram of a system according to an embodiment of the present invention.

FIG. 4 is a block diagram of an example embodiment of the present invention.

### DETAILED DESCRIPTION OF THE INVENTION

A description of example embodiments of the invention follows.

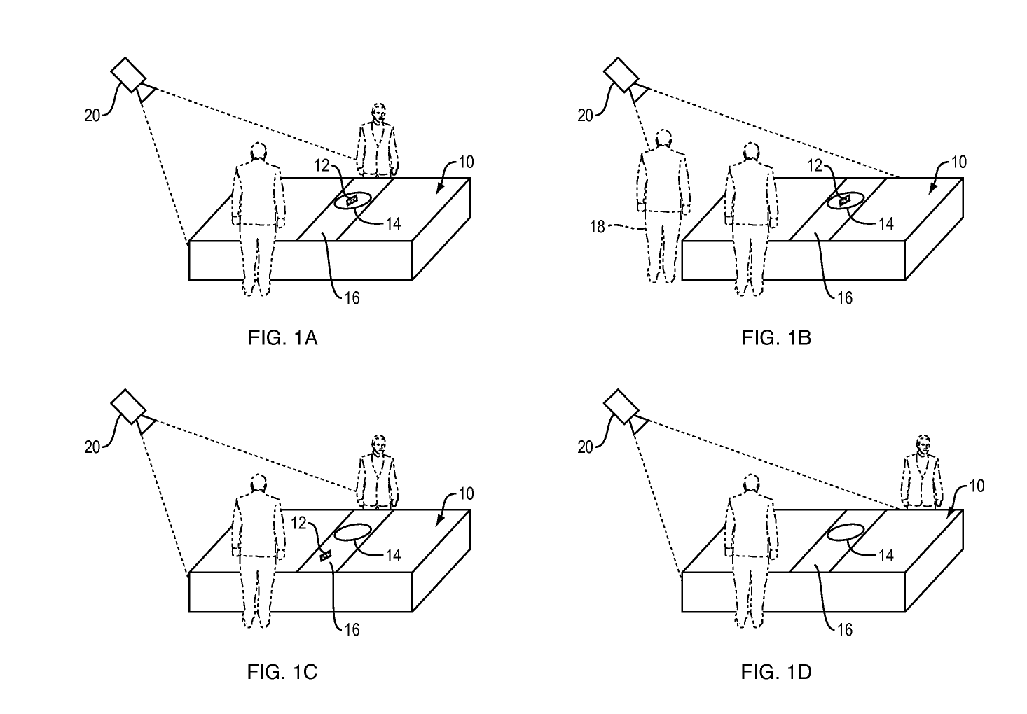

An embodiment of the present invention may be a method and a system useful for distinguishing object removal from object rearrangement, or from object occlusion by another object. Determining such distinctions can be useful, for example, in reducing false alarms in a case in which a surveillance camera is used to monitor security of an object, such as artwork or jewelry, and report a theft should the object be moved or removed from its expected location. The operation of the method and system of the present invention is illustrated in FIGS. 1A, 1B, 1C, and 1D.

FIG. 1A shows a monitored volume 10 that includes content (e.g., an object) 12 located within an area 14. In this embodiment, the volume 10 is being monitored by a camera 20. The object 12 is located within a range of depths of field 16 of camera 20.

FIG. 1B illustrates an occlusion of the content (object) within the monitored volume. Here, another object 18 (e.g., a person) is occluding the object 12 within the field of view of the camera 20. The object 12, however, remains within the volume 10.

FIG. 1C illustrates a rearrangement of the content (object) 12 within the monitored volume 10. Here, the object 12 is being rearranged within the volume 10. Although the object 12 is no longer within the area 14, it remains within range of depths of field 16 of the camera 20.

FIG. 1D illustrates the removal of the content (object) 12 from the monitored volume 10. Here, the object 12 is no longer within the volume 10.

The object removal detection method described herein is based on a combination of scene pattern change and depth information change. In addition to detecting scene pattern change, additional depth information change is also detected. The scene depth changes can be classified into three categories:
1. If an observed scene change happened in the same plane as a previous scene during the monitoring, either the object or the camera was moved.
2. If an observed scene change happened behind a previous scene, there is very high possibility that an object was removed from the scene.
3. If an observed scene change happened in front of a previous scene, the object is being blocked.

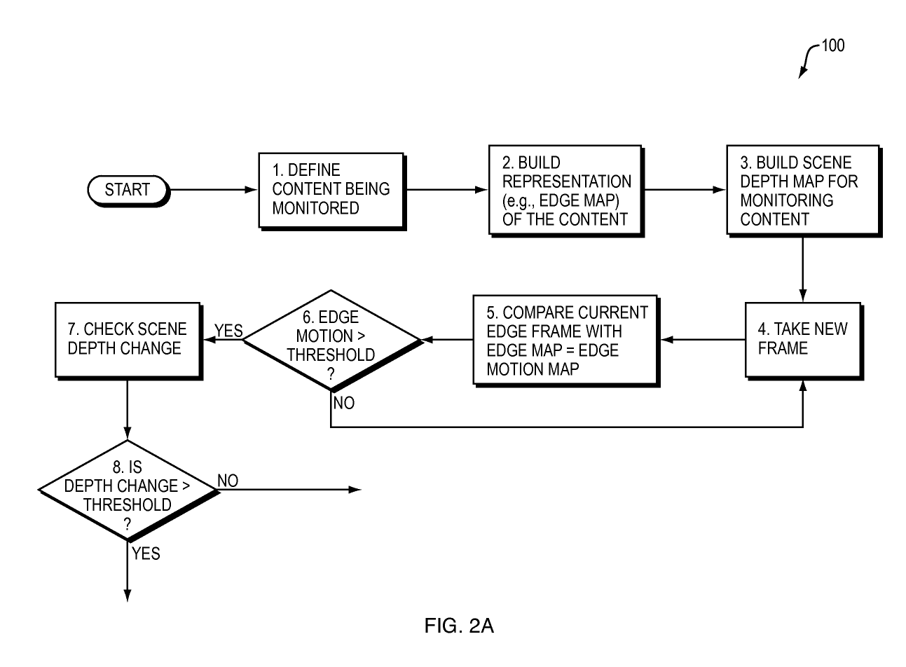

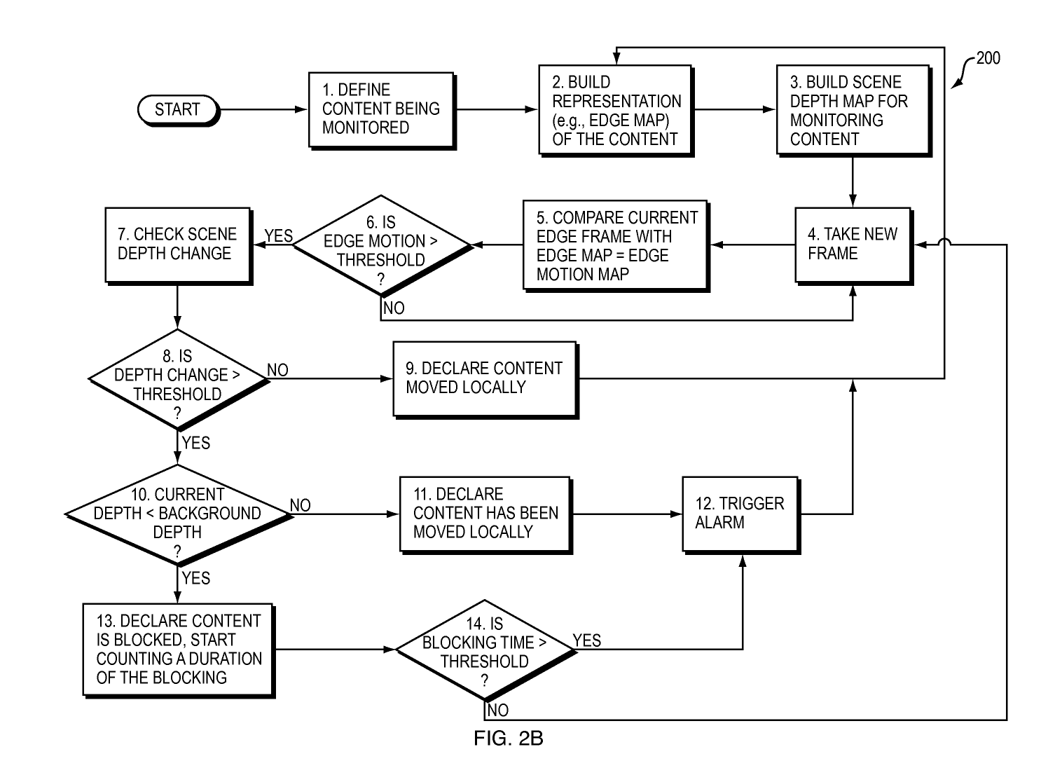

Embodiments of the invention will now be further explained with reference to FIG. 2A and FIG. 2B.

FIG. 2A depicts a method 100 useful for practicing an embodiment of the present invention.

After the method starts, a user defines a volume as well as objects within the volume that to be monitored (1). If not specifically defined, the whole scene can be set as a default area.

After a reference image and a subsequent image are taken by an image acquisition device, such as a camera, a representation of content in the reference image of a monitored volume is built, also referred to herein as “constructed,” to create a reference representation (2). The representation can be an edge map, a luminance of the content of the objects in the image (the content), or a color of the objects in the image. In one embodiment, to reduce lighting variation due to environment reflection, a binary edge background method is employed. In one embodiment, a Canny edge detection algorithm is used, as well as a running Gaussian, to build an edge background.

Thereafter, scene depth information is obtained and the method 200, and builds a scene (3). Any existing stereoscopic image acquisition technology can be used, e.g., Microsoft Kinect®. In one embodiment, to build scene depth, a block of 8×8 pixels is used to average surrounding depth in a spatial domain, and a running Gaussian method is used to average in time domain. Based on the scene depth, a “reference” depth of field value is assigned to the reference representation obtained while building the edge map.

A subsequent image is next acquired (4), and a representation of a content in a subsequent image of the monitored volume is constructed to create a subsequent representation. The subsequent image is time-ordered with respect to the reference image.

The subsequent representation is compared to the reference representation to determine motion of the content (5). This can be accomplished by calculating image edge map differences between the images. To remove a camera shaking effect, a subtraction used to calculated the differences can be performed by using a 3×3 block of pixels. As long as the two blocks have the same edge number, the blocks are considered to be equal, and their edge distribution is ignored.

The motion of the monitored object is detected by relying on the representations. In one embodiment, if an edge percentage change is greater than a predefined sensitivity, the motion is deemed detected, and the method 200 proceeds to check if there has been a scene depth change (7). Optionally, a block-based method may be employed, where the block-based method works through use of blocks of pixels rather than individual pixels. If the change is less than the predetermined threshold the method 200 repeats by acquiring a next subsequent image (4).

In an event that the motion is detected (6), a subsequent depth of field value is assigned to the subsequent representation.

The subsequent and reference depth of field values of the subsequent representation and the reference representation, respectively, are compared (8). Based on this comparison, rearrangement, removal or occlusion of the content is determined. This determination can be accomplished, for example, by method 200, described below with reference to FIG. 2B.

FIG. 2B depicts a method 200 useful for practicing an embodiment of the present invention.

After the method starts, a user defines a volume as well as objects within the volume that to be monitored (1). If not specifically defined, the whole scene can be set as a default area.

After a reference image and a subsequent image are taken by an image acquisition device, such as a camera, a representation of a content in the reference image of a monitored volume is built, also referred to herein as “constructed,” to create a reference representation (2). The representation can be an edge map, a luminance of the content of the objects in the image (the content), or a color of the objects in the image. In one embodiment, to reduce lighting variation due to environment reflection, a binary edge background method is employed. In one embodiment, a Canny edge detector is used, as well as a running Gaussian, to build an edge background.

Thereafter, scene depth information is obtained and the method 200, and builds a scene (3). Any existing stereoscopic image acquisition technology can be used, e.g., Microsoft Kinect®. In one embodiment, to build scene depth, a block of 8×8 pixels is used to average surrounding depth in a spatial domain, and a running Gaussian is used to average in time domain. Based on the scene depth, a “reference” depth of field value is assigned to the reference representation obtained while building the edge map.

A subsequent image is next acquired (4), and a representation of a content in a subsequent image of the monitored volume is constructed to create a subsequent representation. The subsequent image is time-ordered with respect to the reference image.

The subsequent representation is compared to the reference representation to determine motion of the content (5). This can be accomplished by calculating image edge map differences between the images. To remove a camera shaking effect, a subtraction used to calculated the differences can be performed by using a 3×3 block of pixels. As long as the two blocks have the same edge number, the blocks are considered to be equal, and their edge distribution is ignored.

The motion of the monitored object is detected by relying on the representations. In one embodiment, if an edge percentage change is greater than a predefined sensitivity, the motion is deemed detected, and the method 200 proceeds to check if there has been a scene depth change (7). Optionally, a block-based method may be employed, where the block-based method works through use of blocks of pixels rather than individual pixels. If the change is less than the predetermined threshold the method 200 repeats by acquiring a next subsequent image (4).

In an event that the motion is detected (6), a subsequent depth of field value is assigned to the subsequent representation.

The subsequent and reference depth of field values of the subsequent representation and the reference representation, respectively, are compared (8) to determine whether the content was subject to rearrangement, removal or occlusion.

If the depth change is not greater than a threshold, the method 200 declares that the object was subjected to rearrangement (i.e., the object moved or was moved locally). In this case, a new reference image is acquired (not shown), and the process 200 repeats (2)-(8) on the new reference image.

If the depth change is greater than the threshold (8), the method (200) determines whether the object was removed or occluded by comparing the current depth with a background depth (10).

If the current depth of the object is not less than the background (10), then the method declares that the object has been removed (11). In this case, a signal indicating removal of an object is produced (12), such as by triggering an alarm. If the current depth of the object is less than the background depth (10), then the method 200 declares that the object has been occluded (13). In this case, the period of occlusion is timed (13), and, if the time of occlusion is less than a predetermined threshold (14), a new subsequent image (4) is taken and (5) through (8) are performed on the subsequent image.

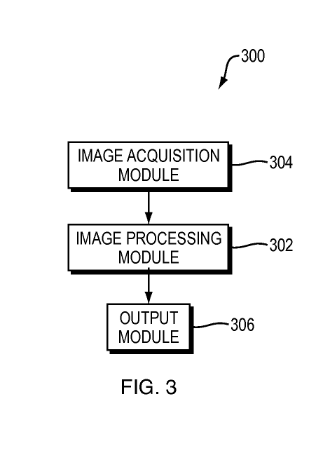

FIG. 3 is a block diagram of a system 300 according to an example embodiment of the present invention. The system 300 includes an image processing module 302. The image processing module 302 is configured to construct a representation of a content in a reference image of a monitored volume to create a reference representation; assign a depth of field value to the reference representation; construct a representation of a content in a subsequent image of the monitored volume to create a subsequent representation, the subsequent image being time-ordered with, with respect to the reference image; compare the subsequent representation to the reference representation to determine motion of the content, and, in an event motion of the content was detected, to assign a depth of field value to the subsequent representation; and to comparing the depth of field values of the subsequent representation and the reference representation to determine whether the content was subject to rearrangement, removal or occlusion.

The system 300 may further include an image acquisition module 304, configured to acquire the reference image and the subsequent image.

System 300 can further include an output module 306, configured to produce an alarm or other signal, indicating removal of the content.

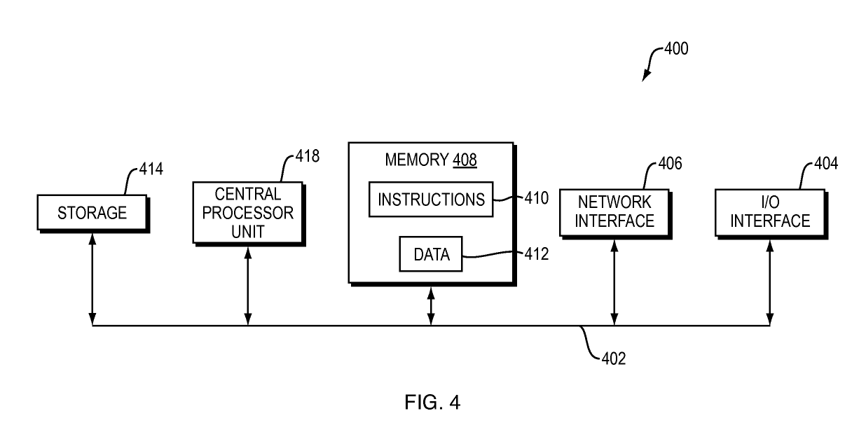

FIG. 4 is a block diagram of an example internal structure of a system 400 in which various embodiments of the present invention may be implemented. The system 400 contains a system bus 402, where a bus is a set of hardware lines used for data transfer among the components of the system 400. The bus 402 is essentially a shared conduit that couples different elements of a system (e.g., processor, disk storage, memory, input/output ports, network ports, etc.) that enables the transfer of information between the elements. Coupled to the system bus 402 is an I/O device interface 404 for coupling various input and output devices (e.g., keyboard, mouse, displays, printers, speakers, etc.) to the system 400. A network interface 406 allows the system 400 to couple to various other devices attached to a network. Memory 408 provides volatile storage for the computer software instructions 410, and the data 412 may be used to implement embodiments of the present invention. Disk storage 414 provides non-volatile storage for computer software instructions 410 and data 412 that may be used to implement embodiments of the present invention. A central processor unit 418 is also coupled to the system bus 402 and provides for the execution of computer instructions.

Example embodiments of the present invention may be configured using a computer program product; for example, controls may be programmed in software for implementing example embodiments of the present invention. Further example embodiments of the present invention may include a non-transitory computer readable medium containing instruction that may be executed by a processor, and, when executed, cause the processor to complete methods described herein. It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read only memory (CD-ROM), and so forth. In operation, a general purpose or application specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the invention.

While this invention has been particularly shown and described with references to example embodiments thereof, it will be understood by those skilled in the art that various changes in form and details may be made therein without departing from the scope of the invention encompassed by the appended claims.

What is claimed is:

1. A method for monitoring a content of a volume, the method comprising:
constructing a representation of a content in a reference image of a monitored volume to create a reference representation;
assigning a reference depth of field value to the reference representation;
constructing a representation of a content in a subsequent image of the monitored volume to create a subsequent representation, the subsequent image being time-ordered with respect to the reference image;
comparing the subsequent representation to the reference representation to determine motion of the content;
in an event motion of the content is detected:
assigning a subsequent depth of field value to the subsequent representation; and
comparing the subsequent and reference depth of field values of the subsequent representation and the reference representation, respectively, to determine whether the content was subjected to rearrangement, removal or occlusion.

2. The method of claim 1, wherein, in an event the motion in the content is not detected, the method further includes:
replacing the subsequent image with a new subsequent image, time-ordered with respect to the subsequent image;
constructing a representation of a content in the new subsequent image of the monitored volume to create a new subsequent representation;
comparing the new subsequent representation to the reference representation to determine motion of the content; and
in an event motion of the content was detected:
assigning a depth of field value to the new subsequent representation; and
comparing the depth of field values of the new subsequent representation and the reference representation to determine whether the content was subjected to rearrangement, removal or occlusion.

3. The method of claim 1, wherein, in the event the content was subjected to rearrangement, the method further includes:
replacing the reference image with a new reference image;
constructing a representation of a content in the new reference image of the monitored volume to create a new reference representation;
assigning a depth of field value to the new reference representation;
constructing a representation of a content in a new subsequent image of the monitored volume to create a new subsequent representation, the new subsequent image being time-ordered with respect to the new reference image;
comparing the new subsequent representation to the new reference representation to determine motion of the content;
in an event motion of the content was detected:
assigning a depth of field value to the new subsequent representation; and
comparing the depth of field values of the new subsequent representation and the new reference representation to determine whether the content was subject to rearrangement, removal or occlusion.

4. The method of claim 1, wherein, in an event the content was subject to removal, the method further includes producing a signal indicating removal.

5. The method of claim 1, wherein, in an event the content was subject to occlusion, the method further includes timing the period of occlusion.

6. The method of claim 1, wherein the reference representation and the subsequent representation are selected at least from an edge map of an image, a luminance of the content, or a color of the content, and further wherein comparing the subsequent representation to the reference representation to determine motion of the content includes at least one of:
comparing an edge map of the reference image to an edge map of the subsequent image;
comparing a luminance of the content of the reference image to a luminance of the content of the subsequent image; and
comparing a color of the monitored area detected in the reference image to a color of the content of the subsequent image.

7. A system for monitoring a content of a volume, the system comprising an image processing module, configured to:
construct a representation of a content in a reference image of a monitored volume to create a reference representation;
assign a depth of field value to the reference representation;
construct a representation of a content in a subsequent image of the monitored volume to create a subsequent representation, the subsequent image being time-ordered with respect to the reference image;
compare the subsequent representation to the reference representation to determine motion of the content, and, in an event motion of the content was detected,
to assign a depth of field value to the subsequent representation and to compare the depth of field values of the subsequent representation and the reference representation to determine whether the content was subject to rearrangement, removal or occlusion.

8. The system of claim 7, further including an image acquisition module configured to acquire the reference image and the subsequent image.

9. The system of claim 7, further including an output module, configured to produce a signal indicating removal of the content.

10. An apparatus for monitoring a content of a volume, the apparatus comprising:
at least one processor; and
at least one memory with computer code instructions stored thereon,
the at least one processor and the at least one memory with the computer code instructions being configured to cause the apparatus to perform at least the following:
construct a representation of a content in a reference image of a monitored volume to create a reference representation;
assign a depth of field value to the reference representation;
construct a representation of a content in a subsequent image of the monitored volume to create a subsequent representation, the subsequent image being time-ordered with respect to the reference image;
compare the subsequent representation to the reference representation to determine motion of the content, and, in an event motion of the content was detected,
to assign a depth of field value to the subsequent representation and to compare the depth of field values of the subsequent representation and the reference representation to determine whether the content was subject to rearrangement, removal or occlusion.

11. The apparatus of claim 10, wherein, in an event the motion in the content is not detected, the at least one processor and the at least one memory with the computer code instructions is configured to cause the apparatus to perform at least the following:
replace the subsequent image with a new subsequent image, time-ordered with respect to the subsequent image;
construct a representation of a content in the new subsequent image of the monitored volume to create a new subsequent representation;
compare the new subsequent representation to the reference representation to determine motion of the content; and
in an event motion of the content was detected:
assign a depth of field value to the new subsequent representation; and
compare the depth of field values of the new subsequent representation and the reference representation to determine whether the content was subjected to rearrangement, removal or occlusion.

12. The apparatus of claim 10, wherein, in the event the content was subjected to rearrangement, the at least one processor and the at least one memory with the computer code instructions is configured to cause the apparatus to perform at least the following:
replace the reference image with a new reference image;
construct a representation of a content in the new reference image of the monitored volume to create a new reference representation;
assign a depth of field value to the new reference representation;
construct a representation of a content in a new subsequent image of the monitored volume to create a new subsequent representation, the new subsequent image being time-ordered with respect to the new reference image;
compare the new subsequent representation to the new reference representation to determine motion of the content;
in an event motion of the content was detected:
assign a depth of field value to the new subsequent representation; and
compare the depth of field values of the new subsequent representation and the new reference representation to determine whether the content was subject to rearrangement, removal or occlusion.

13. The apparatus of claim 10, wherein, in an event the content was subject to removal, the at least one processor and the at least one memory with the computer code instructions being configured to cause the apparatus to perform at least the following:
produce a signal indicating removal.

14. The apparatus of claim 10, wherein, in an event the content was subject to occlusion, the at least one processor and the at least one memory with the computer code instructions being configured to cause the apparatus to perform at least the following:
time the period of occlusion.

15. The apparatus of claim 10, wherein the reference representation and the subsequent representation are selected at least from an edge map of an image, a luminance of the content, or a color of the content, and further wherein
the at least one processor and the at least one memory with the computer code instructions being configured to cause the apparatus to perform comparing the subsequent representation to the reference representation to determine motion of the content by at least one of:
comparing an edge map of the reference image to an edge map of the subsequent image;
comparing a luminance of the content of the reference image to a luminance of the content of the subsequent image; and
comparing a color of the monitored area detected in the reference image to a color of the content of the subsequent image.

16. The apparatus of claim 10, further including an image acquisition module configured to acquire the reference image and the subsequent image.

17. The apparatus of claim 10, further including an output module, configured to produce a signal indicating removal of the content.
